(19) United States
(12) Patent Application Publication
(10) Pub. No.: US 2024/0430768 A1
(43) Pub. Date: Dec. 26, 2024

(54) DETERMINING FREQUENCY PRIORITIZATION IN WIRELESS COMMUNICATION

(71) Applicant: Lenovo (Singapore) Pte. Ltd., New Tech Park (SG)

(72) Inventor: Prateek Basu Mallick, Dreieich (DE)

(21) Appl. No.: 18/703,054

(22) PCT Filed: Oct. 14, 2022
(86) PCT No.: PCT/IB2022/059889

§ 371 Date: Apr. 19, 2024

Related U.S. Application Data
(60) Provisional application No. 63/257,262, filed on Oct. 19, 2021.

(51) Int. Cl. H04W 36/24

(52) U.S. Cl. CPC H04W 36/24

(57) ABSTRACT

Apparatuses, methods, and systems are disclosed for determining frequency prioritization in wireless communication. One method (500) includes receiving (500), at a user equipment (“UE”), slice group information from a network device. The method (500) includes determining (504) a cell reselection priority of a plurality of frequencies including a first frequency and a second frequency. The method (500) includes determining (506) reselection priorities of a plurality of frequencies for performing slice group-based cell reselection.

### CROSS-REFERENCE TO RELATED APPLICATIONS

This application claims priority to U.S. Patent Application Ser. No. 63/257,262 entitled “APPARATUSES, METHODS, AND SYSTEMS FOR CELL RESELECTION BASED ON NETWORK SLICING” and filed on Oct. 19, 2021 for Prateek Basu Mallick et al., which is incorporated herein by reference in its entirety.

### FIELD

The subject matter disclosed herein relates generally to wireless communications and more particularly relates to determining frequency prioritization in wireless communication.

### BACKGROUND

In certain wireless communications systems, frequency prioritization may be inefficient and/or may have high power consumption.

### BRIEF SUMMARY

Methods for determining frequency prioritization in wireless communication are disclosed. Apparatuses and systems also perform the functions of the methods. One embodiment of a method includes receiving, at a user equipment (“UE”), slice group information from a network device. In some embodiments, the method includes determining a cell reselection priority of a plurality of frequencies including a first frequency and a second frequency. In certain embodiments, the method includes determining reselection priorities of a plurality of frequencies for performing slice group-based cell reselection.

One apparatus for determining frequency prioritization in wireless communication includes a processor. In some embodiments, the apparatus includes a memory coupled to the processor, the processor configured to cause the apparatus to: receive slice group information from a network device; determine a cell reselection priority of a plurality of frequencies including a first frequency and a second frequency; and determine reselection priorities of a plurality of frequencies for performing slice group-based cell reselection.

Another embodiment of a method for determining frequency prioritization in wireless communication includes receiving, at a UE, slice group information via a NAS communication from a network device. In some embodiments, the method includes determining a prioritized list of frequencies for performing slice based cell reselection.

Another apparatus for determining frequency prioritization in wireless communication includes a processor. In some embodiments, the apparatus includes a memory coupled to the processor, the processor configured to cause the apparatus to: receive slice group information via a NAS communication from a network device; and determine a prioritized list of frequencies for performing slice based cell reselection.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for determining frequency prioritization in wireless communication;

FIG. 2 is a schematic block diagram illustrating one embodiment of an apparatus that may be used for determining frequency prioritization in wireless communication;

FIG. 3 is a schematic block diagram illustrating one embodiment of an apparatus that may be used for determining frequency prioritization in wireless communication;

FIG. 4 is a schematic block diagram illustrating one embodiment of a system for cell and frequency deployment;

FIG. 5 is a flow chart diagram illustrating one embodiment of a method for determining frequency prioritization in wireless communication; and

FIG. 6 is a flow chart diagram illustrating another embodiment of a method for determining frequency prioritization in wireless communication.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

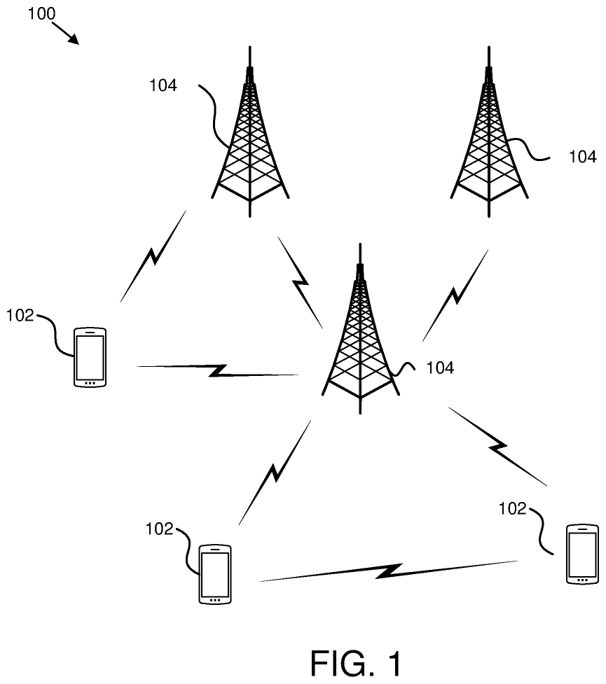

FIG. 1 depicts an embodiment of a wireless communication system 100 for determining frequency prioritization in wireless communication. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfox, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a remote unit 102 may receive slice group information from a network device. In some embodiments, the remote unit 102 may determine a cell reselection priority of a plurality of frequencies including a first frequency and a second frequency. In certain embodiments, the remote unit 102 may determine reselection priorities of a plurality of frequencies for performing slice group-based cell reselection. Accordingly, the remote unit 102 may be used for determining frequency prioritization in wireless communication.

In certain embodiments, a remote unit 102 may receive slice group information via a NAS communication from a network device. In some embodiments, the remote unit 102 may determine a prioritized list of frequencies for performing slice based cell reselection. Accordingly, the remote unit 102 may be used for determining frequency prioritization in wireless communication.

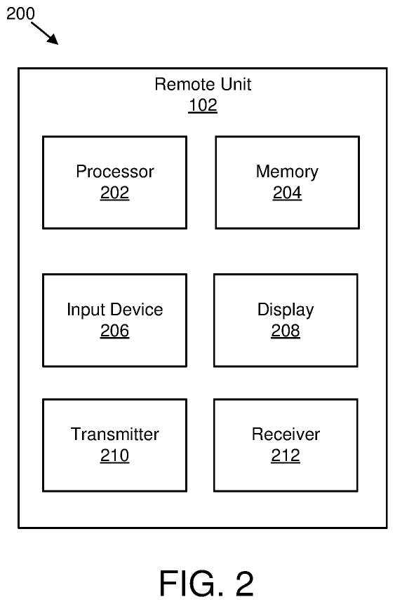

FIG. 2 depicts one embodiment of an apparatus 200 that may be used for determining frequency prioritization in wireless communication. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

In certain embodiments, the processor 202 is configured to cause the apparatus to; receive slice group information from a network device: determine a cell reselection priority of a plurality of frequencies including a first frequency and a second frequency: and determine reselection priorities of a plurality of frequencies for performing slice group-based cell reselection.

In certain embodiments, the processor 202 is configured to cause the apparatus to: receive slice group information via a NAS communication from a network device; and determine a prioritized list of frequencies for performing slice based cell reselection.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

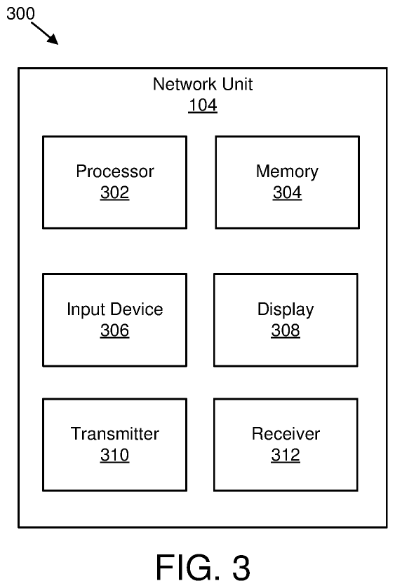

FIG. 3 depicts one embodiment of an apparatus 300 that may be used for determining frequency prioritization in wireless communication. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

It should be noted that one or more embodiments described herein may be combined into a single embodiment.

In certain embodiments, fifth generation (“5G”) network slicing is a network architecture that enables multiplexing of virtualized and independent logical networks on the same physical network infrastructure. Each network slice is an isolated end-to-end network tailored to fulfil diverse requirements requested by a particular application. In such embodiments, this technology assumes a central role to support 5G mobile networks that are designed to efficiently embrace a plethora of services with very different service level requirements (“SLR”). The realization of this service-oriented view of the network leverages on the concepts of software-defined networking (“SDN”) and network function virtualization (“NFV”) that allows the implementation of flexible and scalable network slices on top of a common network infrastructure.

In some embodiments, there is a strong demand in wireless communication in vertical markets as connectivity and mobility empower the transformation and innovation in industries such as manufacturing, transportation, energy and civil services, healthcare, and many more. These diverse vertical services may bring about a wide range of performance requirements in throughput, capacity, latency, mobility, reliability, position accuracy, and so forth. New radio (“NR”) technology may use a common radio access network (“RAN”) platform to meet the challenges of current and future use cases and services, not only for those that can be envisioned today, but also for those that cannot yet be imagined. Network slicing may advance network architecture towards more flexibility and higher scalability for a multitude of services of disparate requirements.

In various embodiments, there may be RAN support of network slicing to make a tool that network operators can apply to meet the challenge of opening a new source of revenue in addition to one derived from customer subscription. More particularly, there may be technical tools in RAN for network operators to get application providers involved in customizing RAN's design, deployment, and operation for better support of the applications providers' business.

In certain embodiments, slice based cell reselection may be supported and mechanisms and signaling may be specified, such as: 1) to assist cell reselection, broadcast the supported slice info of the current cell and neighbor cells, and cell reselection priority per slice in system information message; and/or 2) to assist cell reselection, include slice information (e.g., with similar information as in a system information (“SI”) message) in a message (e.g., radio resource control (“RRC”) release message).

In some embodiments, there may be slice (e.g., single (“S”) network slice selection assistance information (“NSSAI”)) (“S-NSSAI”)) based cell reselection and the following may apply: the “slice info” (e.g., for a single slice or slice group) to be provided to a UE using both broadcast and dedicated signaling is provided for a serving cell as well as neighboring frequencies. The following steps are used for slice based cell selection and/or reselection in an access stratum (“AS”) protocol: 1) step 0: non-access stratum (“NAS”) layer at the UE provides slice information to the AS layer at the UE including slice priorities; 2) step 1: the AS sorts slices in priority order starting with a highest priority slice; 3) step 2: select slices in priority order starting with the highest priority slice; 4) step 3: for the selected slice assign priority to frequencies received from a network; 5) step 4: starting with the highest priority frequency, perform measurements; 6) step 5: if the highest ranked cell is suitable and supports the selected slice in step 2 then camp on the cell and exit this sequence of operation (e.g., it may be determined how the UE determines whether the highest ranked cell supports the selected slice); 7) step 6: if there are remaining frequencies then go back to step 4; 8) step 7: if the end of the slice list has not been reached go back to step 2; and/or 9) step 8: perform legacy cell reselection.

In various embodiments, a slice-based cell reselection procedure is done in the following way: 1) the UE selects a slice group with a highest priority slice; 2) the UE assigns the slice frequency priority corresponding to the selected slice group for NR frequencies received in RRCRelease or in system information messages; 3) the UE performs measurements and selects the highest ranked and suitable cell as candidate for camping using the slice group specific NR frequency priorities; 4) if the highest ranked and suitable cell supports the selected slice, then the UE camps on the cell—if the highest ranked suitable cell does not support the selected slice, then the UE excludes the frequency of that cell from cell reselection with frequency priorities of the selected slice group and continues the search for suitable cells with the assigned slice group specific frequency priorities on other frequencies if there is any; and 5) if no suitable cell is found using slice group specific frequency priorities then the UE continues to perform cell reselection without considering slice group specific frequency priorities.

In such embodiments, cell reselections for a UE can't blindly assume that slice support on a frequency is uniform (e.g., all the cells on the frequency support the same set of slices). Therefore, serving cell broadcasting slice support just for neighboring frequencies may not be sufficient and a UE may need to determine if the highest ranked cell supports the selected slice (e.g., the slice from step 2).

In certain embodiments, there may be measurement rules for cell re-selection. The following rules are used by a UE to limit needed measurements: 1) if the serving cell fulfils Srxlev>S_{IntraSearchP} and Squal>S_{IntraSearchQ}, the UE may choose not to perform intra-frequency measurements; 2) otherwise, the UE may perform intra-frequency measurements; and 3) the UE may apply the following rules for NR inter-frequencies and inter-radio access technology (“RAT”) frequencies which are indicated in system information and for which the UE has priority as follows: a) for a NR inter-frequency or inter-RAT frequency with a reselection priority higher than the reselection priority of the current NR frequency, the UE may perform measurements of higher priority NR inter-frequency or inter-RAT frequencies, b) for a NR inter-frequency with an equal or lower reselection priority than the reselection priority of the current NR frequency and for inter-RAT frequency with lower reselection priority than the reselection priority of the current NR frequency: a1) if the serving cell fulfils Srxlev>S_{nonIntraSearchP} and Squal>S_{nonIntraSearchQ}, the UE may choose not to perform measurements of NR inter-frequencies or inter-RAT frequency cells of equal or lower priority, and a2) otherwise, the UE may perform measurements of NR inter-frequencies or inter-RAT frequency cells of equal or lower priority.

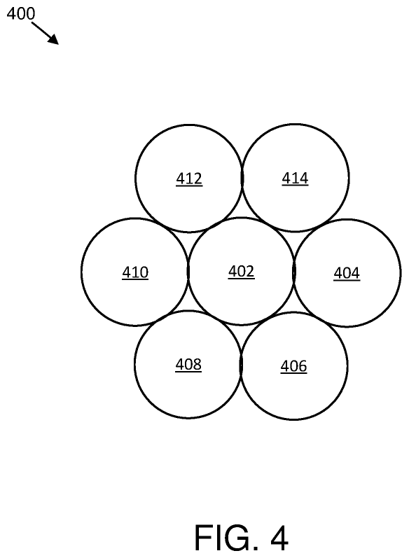

FIG. 4 is a schematic block diagram illustrating one embodiment of a system 400 for cell and frequency deployment. The system 400 includes a serving cell 402 on current frequency f0, a N-cell-B1 404 on neighbor frequency f1, a N-cell-B2 406 on neighbor frequency f1, a N-cell-B3 408 on neighbor frequency f2, a N-cell-B4 410 on neighbor frequency f2, a N-cell-B5 412 on neighbor frequency f3, and a N-cell-B6 414 on neighbor frequency f3.

In one reselection mechanism, a determination is made if inter-frequency and/or inter-RAT measurements need to be started for higher priority or for lower and/or equal priority frequencies. Here, the higher or lower and/or equal frequency priority are determined based on a comparison between a cell reselection priority of a candidate inter-frequency and/or inter-RAT frequency (e.g., neighbor frequency) and a cell reselection priority of a current NR frequency. Different performance requirements apply to measurements of and cell reselection on higher priority frequencies than those of lower and/or equal priority frequencies; the latter being started only when a serving cell does not fulfil Srxlev>S_{nonIntraSearchP} and Squal>S_{nonIntraSearchQ} anymore. On the contrary, NR inter-frequency or inter-RAT frequency with a reselection priority higher than the reselection priority of the current NR frequency goes on continuously. The UE may perform measurements of higher priority NR inter-frequency or inter-RAT frequencies according to predetermined procedures.

In some embodiments, it may be determined what is considered to be a reselection priority of a current NR and neighbor frequency. The frequency priority for network slicing based slice priority and a corresponding frequency priority may be considered and/or may be dependent on the slices that are supported on the current NR frequency. In absence of this (e.g., priority of the current NR and neighbor frequency), a determination cannot be made if other neighboring frequencies are considered to have a higher or lower priority (or the same priority) than the priority of the serving frequency.

In various embodiments, legacy cell reselection priorities of involved frequencies (e.g., cell reselection priority of current NR and neighbor frequency) may be used for determining which neighbor frequencies are considered to have a higher priority than the current frequency and which neighbor frequencies are considered to have a lower and/or the same priority than the current frequency.

In certain embodiments, this may not be optimum and may lead to strange behavior expending UE battery in measuring neighboring frequencies unnecessarily if a UE is camped on a cell on a highest priority frequency of this UE's highest priority slice, but may still need to perform neighbor frequency measurements since the configured legacy CellReselectionPriorities in the cell lead to a scenario where some neighbour frequencies are considered higher priority than the current frequency. Since the highest priority slice is UE specific, a network hardly has any possibility to avoid such unwanted situation for all UEs camped on that cell.

As may be appreciated, the following terms are used herein as defined: 1) slice info (e.g., information): frequency priority mapping for each slice (e.g., slice->frequency(ies)->absolute priority of each of the frequency)-the slice info includes three elements (e.g., slice, frequency, and an absolute frequency priority)-the slice info (for a slice or slice group) may be provided to the UE using both broadcast and dedicated signaling-slice info is provided for the serving as well as neighboring frequencies; 2) slice support: the slice(s) and/or slice group(s) supported in a particular cell or frequency.

It should be noted that, while the term slice may be used herein, the corresponding methods and/or embodiments may be equally applicable to a slice group. A slice group includes one or more slices, where one slice belongs to one and only one slice group and each slice group is uniquely identified by a slice group identifier. This may avoid publishing slice identities (e.g., S-NSSAI) in system information (“SI”) (e.g., thereby facilitating reducing a security concern and an SI size concern). In various embodiments, signaling of slice grouping and a slice group identity may be indicated in NAS signaling to a UE.

In a first embodiment, a UE determines a cell reselection priority of a frequency (e.g., a current NR or neighbor frequency) as a highest frequency priority corresponding to any slice among slices supported on a concerned frequency. Table 1 illustrates one example of slice info broadcasted or provided dedicatedly to a UE.

TABLE 1
p1, p2, p3 are cell reselection priorities of a frequency

| | | |
|---|---|---|
| Slice-1 | f1 | p1 |
| | f2 | p2 |
| | f3 | p3 |
| slice-2 | f2 | p1 |
| | f3 | p2 |
| | f4 | p3 |

In some embodiments, a UE rearranges Table 1 into Table 2.

TABLE 2

| | |
|---|---|
| f1 | slice-1 |
| f2 | slice-1 |
| | slice-2 |
| f3 | slice-1 |
| | slice-2 |
| f4 | slice-2 |

In a next step, the UE determines priority of a frequency as a maximum among priorities assigned to that frequency corresponding to any of the slices that are indicated as supported by the particular frequency, as shown in Table 3 [symbol] Error! Reference source not found.

TABLE 3

| | | |
|---|---|---|
| f1 | slice-1 | p1 |
| f2 | slice-1 | Max(p2, p1) = p2 |
| | slice-2 | |
| f3 | slice-1 | Max(p3, p2) = p3 |
| | slice-2 | |
| f4 | slice-2 | p3 |

In Table 3, p1<p2<p3<p4.

In the example shown in Tables 1 through 3, a UE camped on a cell on frequency f2 will determine f3 and f4 has having a higher priority and perform inter-frequency measurements of f3 and f4. But a UE camped on a cell on frequency f3 need not perform any inter-frequency measurements (e.g., unless the serving cell does no more fulfil Srxlev>S_{nonIntraSearchP} and Squal>S_{nonIntraSearchQ} and, in that case, the UE shall measure all neighbour frequencies f1, f2 and f4 in this example since these are considered inter-frequencies or inter-RAT frequency cells of equal or lower priority).

In one sub-embodiment of the first embodiment, the UE shall only consider information related to a slice that has been indicated as part of a UE's slice list by a UE-NAS (e.g., the slice is listed in the allowed slice list during a NAS registration procedure; or the NAS indicates a list of subscribed or allowed slice list to an AS).

In a second embodiment, a UE starts by taking a highest priority slice in a slice list indicated by a UE-NAS to an AS (e.g., the highest priority slice listed in the allowed slice list) and then a cell reselection priority of a frequency is determined as a frequency priority (e.g., cell reselection priority) of a frequency supporting this highest priority slice. It is possible that, for a certain frequency, a slice is not supported on that frequency, and, in this case, the cell reselection priority of a frequency is determined as a lowest priority (e.g., lower than any of the network configured values). Taking the example from [symbol] Error! Reference source not found, the applicable cell reselection priorities for a UE which has only slice-1 in its list, looks as shown in [symbol] Error! [symbol] Reference source not found.

TABLE 4

| | |
|---|---|
| f1 | p1 |
| f2 | p2 |
| f3 | p3 |
| f4 | lowest |

As a variation of the second embodiment, instead of assigning a lowest priority to a frequency not supporting a particular UE's highest priority slice, a UE uses a next lower priority slice to derive a frequency priority of that slice. Only if none of the UE's slices are supported on that frequency, the cell reselection priority of that frequency is determined as the lowest (e.g., lower than any of the network configured values).

As another variation of the second embodiment, instead of a UE's highest priority slice, a slice that is supported on maximum (e.g., current and neighbor) frequencies is taken into account.

In a third embodiment, a UE only measures a serving cell and uses only legacy radio thresholds to determine if inter-frequency and/or RAT measurements need to be performed. The UE does not evaluate if a NR inter-frequency or inter-RAT frequency has a reselection priority higher, equal, and/or lower than a reselection priority of a current NR frequency. The neighbor frequencies are measured if and/or when the serving cell no more fulfils Srxlev>S_{nonIntraSearchP} and Squal>S_{nonIntraSearchQ}.

In a fourth embodiment, new measurement rules for cell re-selection where a broadcasted slice is supported on a serving cell is considered instead of the slice supported on a serving frequency. Slice support on a frequency is defined as a slice supported on any cell (e.g., neighboring cell) on this frequency. Since cells on a frequency may belong to different tracking areas (“TA”), it may be possible that the slice supported on different cells on the same frequency are also different. It is therefore possible that a serving cell supports only a subset of slices supported by the serving frequency. The fourth embodiment hinges on a slice supported in a UE's serving cell.

In certain embodiments, for neighboring frequencies, slice support is considered on a frequency level (e.g., not with respect to a particular cell of a neighboring frequency).

In some embodiments, a remaining determination of if an NR inter-frequency or inter-RAT frequency has a reselection priority higher than, equal to, and/or lower than the reselection priority of the current NR frequency is done as described in any embodiment described herein.

A fifth embodiment mimics the fourth embodiment except that instead of a general slice supported on a serving cell or on a frequency, only those slices that are indicate as a UE's slice by NAS to AS (e.g., slices out of a UE's allowed slice list) are considered.

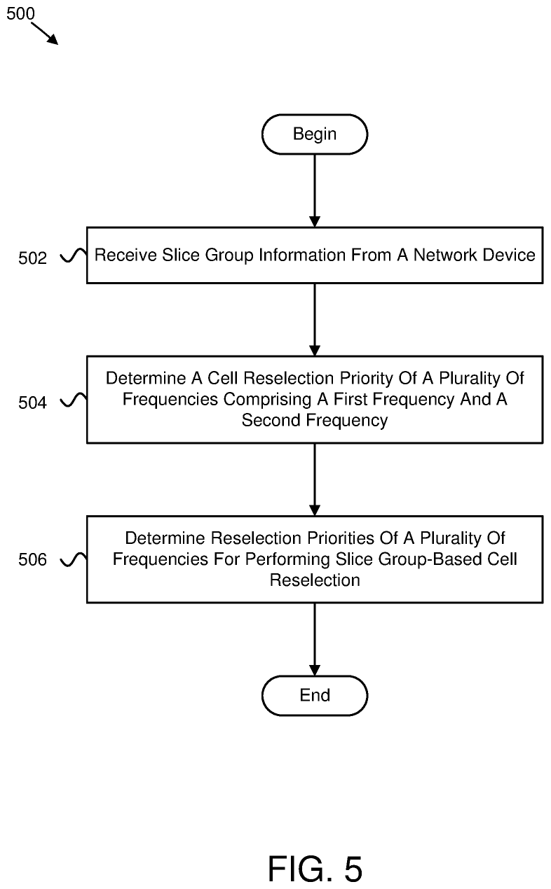

FIG. 5 is a flow chart diagram illustrating one embodiment of a method 500 for determining frequency prioritization in wireless communication. In some embodiments, the method 500 is performed by an apparatus, such as the remote unit 102. In certain embodiments, the method 500 may be performed by a processor executing program code, for example, a microcontroller, a microprocessor, a CPU, a GPU, an auxiliary processing unit, a FPGA, or the like.

In various embodiments, the method 500 includes receiving 502 slice group information from a network device. In some embodiments, the method 500 includes determining 504 a cell reselection priority of a plurality of frequencies including a first frequency and a second frequency. In certain embodiments, the method 500 includes determining 506 reselection priorities of a plurality of frequencies for performing slice group-based cell reselection.

In certain embodiments, the method 500 further comprises determining whether to perform inter-frequency measurements. In some embodiments, the method 500 further comprises, in response to determining to perform inter-frequency measurements, performing the inter-frequency measurements. In various embodiments, the first frequency is a current frequency.

In one embodiment, the second frequency is a frequency of an inter-frequency neighbor cell. In certain embodiments, determining the reselection priorities of the plurality of frequencies comprises determining a highest priority NAS provided slice group in a slice group list indicated by the slice group information. In some embodiments, the slice group list comprises allowed slice groups and their corresponding priorities, subscribed slice groups and their corresponding priorities, configured slice groups and their corresponding priorities, other slice groups and their corresponding priorities, or a combination thereof.

In various embodiments, a lowest priority is assigned to a frequency if it does not support any of the slice groups included in the slice group list. In one embodiment, the method 500 further comprises, in response to none of the plurality of frequencies supporting no slice groups indicated by the slice group information, prioritizing the plurality of frequencies based on an order of their cell reselection priority.

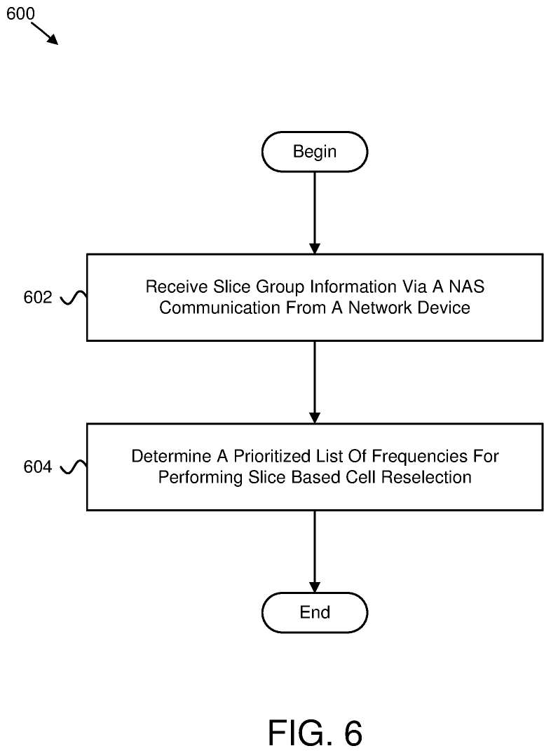

FIG. 6 is a flow chart diagram illustrating another embodiment of a method 600 for determining frequency prioritization in wireless communication. In some embodiments, the method 600 is performed by an apparatus, such as the remote unit 102. In certain embodiments, the method 600 may be performed by a processor executing program code, for example, a microcontroller, a microprocessor, a CPU, a GPU, an auxiliary processing unit, a FPGA, or the like.

In various embodiments, the method 600 includes receiving 602 slice group information via a NAS communication from a network device. In some embodiments, the method 600 includes determining 604 a prioritized list of frequencies for performing slice based cell reselection.

In certain embodiments, the method 600 further comprises determining a shortlisted list of frequencies comprising any signaled frequency as having a higher priority in response to the signaled frequency supporting at least one selected slice group included in a slice list group indicated by the slice group information compared to a frequency not having any slice included in the slice list group. In some embodiments, the method 600 further comprises sorting the shortlisted list of frequencies in an order of priority indicated by the NAS communication to the corresponding slice used for shortlisting, wherein frequencies at a same sorted level are further sorted in an order of frequency priority available in the slice group information of a selected slice group. In various embodiments, a frequency not supporting any of the slice groups received from the NAS list is assigned a frequency reselection priority.

In one embodiment, a slice group corresponding to the slice group information that is indicated to be supported on a frequency is the slice group supported by at least one cell on the frequency. In certain embodiments, a slice group of a cell corresponding to the slice group information is used, and other slice groups are not used.

In one embodiment, an apparatus for wireless communication, the application comprising: a processor; and a memory coupled to the processor, the processor configured to cause the apparatus to: receive slice group information from a network device; determine a cell reselection priority of a plurality of frequencies comprising a first frequency and a second frequency; and determine reselection priorities of a plurality of frequencies for performing slice group-based cell reselection.

In certain embodiments, the processor is further configured to cause the apparatus to determine whether to perform inter-frequency measurements.

In some embodiments, the processor is further configured to cause the apparatus to, in response to determining to perform inter-frequency measurements, perform the inter-frequency measurements.

In various embodiments, the first frequency is a current frequency.

In one embodiment, the second frequency is a frequency of an inter-frequency neighbor cell.

In certain embodiments, the processor configured to cause the apparatus to determine the reselection priorities of the plurality of frequencies further comprises the processor configured to cause the apparatus determine to a highest priority NAS provided slice group in a slice group list indicated by the slice group information.

In some embodiments, the slice group list comprises allowed slice groups and their corresponding priorities, subscribed slice groups and their corresponding priorities, configured slice groups and their corresponding priorities, other slice groups and their corresponding priorities, or a combination thereof.

In various embodiments, a lowest priority is assigned to a frequency if it does not support any of the slice groups included in the slice group list.

In one embodiment, the processor is further configured to cause the apparatus to, in response to none of the plurality of frequencies supporting no slice groups indicated by the slice group information, prioritize the plurality of frequencies based on an order of their cell reselection priority.

In one embodiment, a method at a UE, the method comprises: receiving slice group information from a network device; determining a cell reselection priority of a plurality of frequencies comprising a first frequency and a second frequency; and determining reselection priorities of a plurality of frequencies for performing slice group-based cell reselection.

In certain embodiments, the method further comprises determining whether to perform inter-frequency measurements.

In some embodiments, the method further comprises, in response to determining to perform inter-frequency measurements, performing the inter-frequency measurements.

In various embodiments, the first frequency is a current frequency.

In one embodiment, the second frequency is a frequency of an inter-frequency neighbor cell.

In certain embodiments, determining the reselection priorities of the plurality of frequencies comprises determining a highest priority NAS provided slice group in a slice group list indicated by the slice group information.

In some embodiments, the slice group list comprises allowed slice groups and their corresponding priorities, subscribed slice groups and their corresponding priorities, configured slice groups and their corresponding priorities, other slice groups and their corresponding priorities, or a combination thereof.

In various embodiments, a lowest priority is assigned to a frequency if it does not support any of the slice groups included in the slice group list.

In one embodiment, the method further comprises, in response to none of the plurality of frequencies supporting no slice groups indicated by the slice group information, prioritizing the plurality of frequencies based on an order of their cell reselection priority.

In one embodiment, an apparatus for wireless communication, the apparatus comprises: a processor; and a memory coupled to the processor, the processor configured to cause the apparatus to: receive slice group information via a NAS communication from a network device; and determine a prioritized list of frequencies for performing slice based cell reselection.

In certain embodiments, the processor is further configured to cause the apparatus to determine a shortlisted list of frequencies comprising any signaled frequency as having a higher priority in response to the signaled frequency supporting at least one selected slice group included in a slice list group indicated by the slice group information compared to a frequency not having any slice included in the slice list group.

In some embodiments, the processor is further configured to cause the apparatus to sort the shortlisted list of frequencies in an order of priority indicated by the NAS communication to the corresponding slice used for shortlisting, and frequencies at a same sorted level are further sorted in an order of frequency priority available in the slice group information of a selected slice group.

In various embodiments, a frequency not supporting any of the slice groups received from the NAS list is assigned a frequency reselection priority.

In one embodiment, a slice group corresponding to the slice group information that is indicated to be supported on a frequency is the slice group supported by at least one cell on the frequency.

In certain embodiments, a slice group of a cell corresponding to the slice group information is used, and other slice groups are not used.

In one embodiment, a method at a UE, the method comprises: receiving slice group information via a NAS communication from a network device; and determining a prioritized list of frequencies for performing slice based cell reselection.

In certain embodiments, the method further comprises determining a shortlisted list of frequencies comprising any signaled frequency as having a higher priority in response to the signaled frequency supporting at least one selected slice group included in a slice list group indicated by the slice group information compared to a frequency not having any slice included in the slice list group.

In some embodiments, the method further comprises sorting the shortlisted list of frequencies in an order of priority indicated by the NAS communication to the corresponding slice used for shortlisting, wherein frequencies at a same sorted level are further sorted in an order of frequency priority available in the slice group information of a selected slice group.

In various embodiments, a frequency not supporting any of the slice groups received from the NAS list is assigned a frequency reselection priority.

In one embodiment, a slice group corresponding to the slice group information that is indicated to be supported on a frequency is the slice group supported by at least one cell on the frequency.

In certain embodiments, a slice group of a cell corresponding to the slice group information is used, and other slice groups are not used.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A user equipment (UE), comprising:
at least one memory; and
at least one processor coupled with the at least one memory and configured to cause the UE to:
receive slice group information from a network device;
determine a cell reselection priority of a plurality of frequencies comprising a first frequency and a second frequency; and
determine reselection priorities of a plurality of frequencies for performing slice group-based cell reselection.

2. The UE of claim 1, wherein the at least one processor is configured to cause the UE to determine whether to perform inter-frequency measurements.

3. The UE of claim 2, wherein the at least one processor is configured to cause the UE to, in response to determining to perform inter-frequency measurements, perform the inter-frequency measurements.

4. The UE of claim 1, wherein the first frequency is a current frequency, and the second frequency is a frequency of an inter-frequency neighbor cell.

5. The UE of claim 1, wherein the at least one processor is configured to cause the UE to determine to a highest priority network access stratum (NAS) provided slice group in a slice group list indicated by the slice group information.

6. The UE of claim 5, wherein the slice group list comprises allowed slice groups and their corresponding priorities, subscribed slice groups and their corresponding priorities, configured slice groups and their corresponding priorities, other slice groups and their corresponding priorities, or a combination thereof.

7. The UE of claim 5, wherein a lowest priority is assigned to a frequency if it does not support any of the slice groups included in the slice group list.

8. The UE of claim 1, wherein the at least one processor is configured to cause the UE to, in response to none of the plurality of frequencies supporting no slice groups indicated by the slice group information, prioritize the plurality of frequencies based on an order of their cell reselection priority.

9. A user equipment (UE), comprising:
at least one memory; and
at least one processor coupled with the at least one memory and configured to cause the UE to:
receive slice group information via a non-access stratum (NAS) communication from a network device; and
determine a prioritized list of frequencies for performing slice based cell reselection.

10. The UE of claim 9, wherein the at least one processor is configured to cause the UE to determine a shortlisted list of frequencies comprising any signaled frequency as having a higher priority in response to the signaled frequency supporting at least one selected slice group included in a slice list group indicated by the slice group information compared to a frequency not having any slice included in the slice list group.

11. The UE of claim 10, wherein the at least one processor is configured to cause the UE to sort the shortlisted list of frequencies in an order of priority indicated by the NAS communication to the corresponding slice used for shortlisting, and frequencies at a same sorted level are further sorted in an order of frequency priority available in the slice group information of a selected slice group.

12. The UE of claim 11, wherein a frequency not supporting any of the slice groups received from the NAS is assigned a frequency reselection priority.

13. The UE of claim 10, wherein a slice group corresponding to the slice group information that is indicated to be supported on a frequency is the slice group supported by at least one cell on the frequency.

14. The UE of claim 10, wherein a slice group of a cell corresponding to the slice group information is used, and other slice groups are not used.

15. A processor for wireless communication, comprising:
at least one controller coupled with at least one memory and configured to cause the processor to:
receive slice group information via a non-access stratum (NAS) communication from a network device; and
determine a prioritized list of frequencies for performing slice based cell reselection.

16. A processor for wireless communication, comprising:
at least one controller coupled with at least one memory and configured to cause the processor to:
receive slice group information from a network device;
determine a cell reselection priority of a plurality of frequencies comprising a first frequency and a second frequency; and
determine reselection priorities of a plurality of frequencies for performing slice group-based cell reselection.

17. The processor of claim 16, wherein the at least one controller is configured to cause the processor to determine whether to perform inter-frequency measurements.

18. The processor of claim 17, wherein the at least one controller is configured to cause the processor to, in response to determining to perform inter-frequency measurements, perform the inter-frequency measurements.

19. The processor of claim 16, wherein the first frequency is a current frequency, and the second frequency is a frequency of an inter-frequency neighbor cell.

20. The processor of claim 16, wherein the at least one controller is configured to cause the processor to determine to a highest priority network access stratum (NAS) provided slice group in a slice group list indicated by the slice group information.
